(19) United States
(12) Patent Application Publication
(10) Pub. No.: US 2026/0260805 A1
(43) Pub. Date: Sep. 3, 2026

(54) INDUCTOR, MANUFACTURING METHOD THEREFOR, AND ELECTRONIC DEVICE

(71) Applicants: POCO HOLDING CO., LTD., Shenzhen (CN); HUIZHOU POCO NEW INDUCTOR TECHNOLOGY CO., LTD., Huizhou (CN)

(72) Inventors: Xiongzhi GUO, Shenzhen (CN); Yunfan ZHANG, Shenzhen (CN)

(21) Appl. No.: 19/554,918

(22) Filed: Mar. 3, 2026

(30) Foreign Application Priority Data
Mar. 3, 2025 (CN) 202510240432.8

(51) Int. Cl. H01F 27/30

(52) U.S. Cl. CPC H01F 27/30

(57) ABSTRACT

The present disclosure provides an inductor, a manufacturing method therefor, and an electronic device. The inductor includes a winding and a magnetic member that at least partially covers the winding, where the winding includes a conductive body and a conductive layer disposed on a surface of the conductive body. In the present disclosure, the winding is formed by using a combination of the conductive body and the conductive layer, and the winding is at least partially covered on the magnetic member so that when inductors with the same volume are manufactured, a gap between the winding and a magnetic body can be reduced, which is conducive to reducing direct current resistance (DCR) and improving the current-carrying capability of the inductor.

This application claims priority to Chinese Patent Application No. 202510240432.8 filed with CNIPA on March 3, 2025, the disclosure of which is incorporated herein by reference in its entirety.

### TECHNICAL FIELD

The present disclosure belongs to the technical field of electronics, and specifically relates to an inductor, a manufacturing method therefor, and an electronic device.

### BACKGROUND

An inductor is one of the three major passive components in electronic circuits and mainly implements filtering, oscillation, delay, notch filtering, signal selection, noise filtering, current stabilization, electromagnetic interference suppression, and other functions in the circuits. With the rapid development of electronic technology, especially the rapid spread of mobile consumer electronic terminals, inductors are developing towards miniaturization, thin and lightweight designs, high-frequency operation, high currents, high efficiency, and low electromagnetic interference (EMI). In the related art, manufacturing an inductor includes placing a winding and magnetic powder together into a mold cavity and performing integrated molding via compression molding. However, compression molding tends to cause rupture of an insulating layer on a surface of a coil due to pressure applied in the molding process. Alternatively, magnetic bodies and a coil are manufactured separately and then assembled. Such assembly requires that a relative position between the magnetic bodies and a relative position between the magnetic bodies and the winding be ensured.

Therefore, how to solve the above problems and improve the electromagnetic performance of the inductor has become a key research focus.

### SUMMARY

In view of the deficiencies in the related art, an object of the present disclosure is to provide an inductor, a manufacturing method therefor, and an electronic device. In the present disclosure, a winding is formed by using a combination of a conductive body and a conductive layer, and the winding is at least partially covered with a magnetic member so that when inductors with the same volume are manufactured, a gap between the winding and a magnetic body can be reduced, which is conducive to reducing direct current resistance (DCR) and improving the current-carrying capability of the inductor.

To achieve the object, the present disclosure adopts the technical solutions below.

In a first aspect, the present disclosure provides an inductor. The inductor includes a winding and a magnetic member that at least partially covers the winding, where the winding includes a conductive body and a conductive layer disposed on a surface of the conductive body.

In the present disclosure, the winding is formed by using a combination of the conductive body and the conductive layer so that when inductors with the same volume are manufactured, a gap between the winding and a magnetic body can be reduced, which is conducive to reducing DCR and improving the current-carrying capability of the inductor. Moreover, at least part of the winding is placed within the magnetic member. Since the magnetic member and the winding are formed separately, the magnetic bodies with higher densities can be manufactured to improve the electromagnetic performance.

Preferably, the magnetic member includes:
a first magnetic body, and a groove is defined on a first surface of the first magnetic body, the winding is disposed in the groove, and the winding is attached to an inner wall of the groove; and
a second magnetic body, and the second magnetic body is stacked on the first surface of the first magnetic body and covers the winding.

In the present disclosure, the conductive body is placed in the groove of the first magnetic body, a gap between the conductive body and the magnetic body is filled with the conductive layer, and the second magnetic body is covered on the winding. Since the magnetic bodies and the winding are formed separately, the magnetic bodies with higher densities can be manufactured to improve the electromagnetic performance.

Preferably, the conductive body is provided with conductive pins, and the conductive pins protrude on a surface of the conductive body facing away from the first magnetic body, extend in a direction towards the second magnetic body, and penetrate through the second magnetic body; and a density of the first magnetic body is greater than a density of the second magnetic body, and a permeability of the first magnetic body is greater than a permeability of the second magnetic body.

Preferably, materials of the conductive body and the conductive layer each independently include a metal material and/or a carbon material.

Preferably, the metal material includes any one or a combination of at least two of Au, Pt, Pd, Ag, Cu, Al, Co, Cr, Zn, Ni, Ti, W, Fe, Sn, or In.

Preferably, the conductive body is a conductive strip. For example, the conductive body may be a copper strip, and the copper strip may be formed from copper via a physical or chemical processes.

It is to be noted that a thickness relationship between the conductive body and the conductive layer in the groove is not specifically limited in the present disclosure, and the conductive body and the conductive layer may have the same thickness or different thicknesses.

Preferably, a position relationship between the conductive layer and the conductive body includes at least one of the following:

The conductive layer is formed between the conductive body and the inner wall of the groove and covers an upper end surface of the conductive body. (In this case, an upper end surface of the conductive layer is flush or not flush with the first surface of the first magnetic body)

The conductive layer is formed between the conductive body and the inner wall of the groove, and the upper end surface of the conductive layer is flush with the upper end surface of the conductive body. (In this case, an upper end surface of the winding is flush or not flush with the first surface of the first magnetic body.)

Preferably, a lower end surface of the conductive body is attached to a bottom wall of the groove, or the lower end surface of the conductive body and the bottom wall of the groove are spaced by the conductive layer.

Preferably, an interval between the conductive body and a sidewall of the groove is equal or gradually increases along a thickness direction of the conductive body. For example, a cross-section of the groove is in the shape of an inverted trapezoid, that is, the top is wider than the bottom, which facilitates the manufacturing of the conductive layer.

Preferably, the groove is a strip-shaped groove.

Preferably, the conductive body is the conductive strip.

Preferably, the conductive body has a multi-layer structure or a hollow structure.

Preferably, a conductivity of the conductive layer is greater than a conductivity of the conductive body.

Preferably, a connecting body is provided on the conductive body, and the connecting body is configured to connect multiple conductive bodies to form a conductive structure.

Preferably, a material of the connecting body includes a metal material and/or a carbon material. For example, the metal material includes any one or a combination of at least two of Au, Pt, Pd, Ag, Cu, Al, Co, Cr, Zn, Ni, Ti, W, Fe, Sn, or In.

Preferably, the inductor further includes end electrodes, and the end electrodes are electrically connected to exposed ends of the winding.

Preferably, a material of the end electrodes includes Ag.

In a second aspect, the present disclosure provides a manufacturing method for the inductor as described in the first aspect. The manufacturing method includes the steps below.

A conductive body is at least partially disposed in a magnetic member, and a conductive layer is disposed on a surface of the conductive body to form a winding, to obtain the inductor.

The manufacturing method provided by the present disclosure is simple in process. Since magnetic bodies and the winding are formed separately, the magnetic bodies with higher densities can be manufactured to improve electromagnetic performance.

Preferably, the manufacturing method includes the steps below.
(a) Preparing the first magnetic body with a groove.
(b) Placing the conductive body in the groove of the first magnetic body, and forming the conductive layer in the groove through a metallization process such that the conductive layer is disposed on the surface of the conductive body and located between the conductive body and the groove to obtain the winding, where the winding is attached to the inner wall of the groove.
(c) Stacking a second magnetic body on a first surface of the first magnetic body, and covering the winding.

Preferably, a method for manufacturing the first magnetic body with the groove in step (a) includes the steps below.

Mixing soft magnetic powder and a resin, and performing granulation to obtain granulated powder.

Subjecting the granulated powder to compression molding and a first heat treatment to obtain the first magnetic body with at least one strip-shaped groove.

Preferably, a mass content of the resin is 2%–10% of the mass of the soft magnetic powder, which may be, for example, 2%, 3%, 4%, 5%, 6%, 7%, 8%, 9%, or 10%.

In the present disclosure, the resin acts as a binder to bond the soft magnetic powder together during molding.

Preferably, the soft magnetic powder includes any one or a combination of at least two of iron–silicon–aluminum powder, iron–silicon powder, iron–nickel powder, iron–silicon–chromium powder, amorphous nanocrystalline powder, or carbonyl iron powder.

Preferably, the resin includes a thermosetting resin and/or a thermoplastic resin. For example, the thermosetting resin may be any one or a combination of at least two of epoxy resin, diallyl phthalate resin, phenolic resin, polyimide, polyamide-imide, or silicone resin, and the thermoplastic resin may be any one or a combination of at least two of polyolefin, fluororesin, polyamide, polyester, polycarbonate, polyoxymethylene, acrylonitrile‑butadiene‑styrene copolymer (ABS resin), or styrene‑acrylonitrile copolymer (SAN or AS resin).

Preferably, a pressure for the compression molding is 2–24 T/cm², which may be, for example, 2 T/cm², 5 T/cm², 10 T/cm², 15 T/cm², 20 T/cm², or 24 T/cm².

Preferably, the first heat treatment is performed in a manner of thermal annealing or thermal curing.

It is to be noted that the compression molding causes the soft magnetic powder to undergo elastic deformation and plastic deformation, and the greater the molding pressure, the more severe the deformation. Therefore, a heat treatment is required to relieve internal stress. The thermal annealing is to place the compression-molded first magnetic body in an annealing furnace and perform annealing, which can release the residual stress of the magnetic body introduced during the molding process, and can eliminate internal defects inside the magnetic body generated during the manufacturing process of the magnetic body. Consequently, the thermal annealing can improve the initial permeability of the magnetic body, reduce an iron loss, and enhance the mechanical strength of the magnetic body. The thermal curing is used for curing the resin that bonds the soft magnetic powder. That is, the temperature and purpose of the heat treatment process are determined jointly by the electromagnetic performance to be subsequently achieved by the first magnetic body and a thermal property of the bonding material that bonds the soft magnetic powder.

Preferably, the thermal annealing is performed at a temperature of 300–1000°C, which may be, for example, 300°C, 400°C, 500°C, 600°C, 700°C, 800°C, 900°C, or 1000°C. For example, under a compression molding pressure of 10–24 T/cm² and through the annealing treatment, the first magnetic body with a high density of 50–150 g/cm³ and/or a high permeability of 50– 200 (μ = 50–200) can be formed.

In the present disclosure, an excessively low annealing temperature is insufficient to release the internal residual stress, resulting in a relatively low permeability and a relatively high loss, and an excessively high annealing temperature causes damage to an insulating layer on a surface of the powder, reducing the initial permeability and increasing an eddy current loss.

Preferably, the thermal curing is performed at a temperature of 100–300°C, which may be, for example, 100°C, 200°C, or 300°C.

Preferably, the metallization process in step (b) includes any one or a combination of at least two of a coating method, a sputtering method, a vapor deposition method, an electroplating method, a spraying method, an aerosol deposition method, or a thermal spraying method. For example, a thick copper process may be performed by the electroplating method to form the conductive layer.

Preferably, the coating method includes the steps below.

Coating a conductive paste between the conductive body and the inner wall of the groove and performing a second heat treatment to obtain the conductive layer.

It is to be noted that the second heat treatment may be the same as the first heat treatment. That is, during the first heat treatment, the conductive body and the conductive paste have been placed in the groove, and the first magnetic body and the conductive paste are subjected to the heat treatment together. The second heat treatment may be different from the first heat treatment. That is, when the first heat treatment and the second heat treatment are performed separately, the second heat treatment may be performed after the first heat treatment.

Preferably, the second heat treatment is performed at a temperature higher than 300°C, which may be, for example, 320°C, 350°C, 400°C, 450°C, or 500°C. The conductive paste includes conductive powder and an organic solvent. For example, the conductive powder may be Ag powder, and after the second heat treatment, the Ag powder is bonded together through sintering.

Preferably, the second heat treatment is performed at a temperature lower than or equal to 300°C, which may be, for example, 300°C, 280°C, 250°C, 200°C, or 150°C. The conductive paste includes conductive particles and an organic solvent. The conductive particles include nanoscale particles and microscale particles. For example, both microscale conductive particles and nanoscale conductive particles are silver. At the temperature of the second heat treatment, nanoscale silver particles melt and are connected with microscale silver particles to form an integral structure.

Preferably, in step (c), a method for stacking the second magnetic body includes a hot pressing method or a covering method.

Preferably, the hot pressing method includes the step below.

Hot-pressing a mixture of magnetic powder and a resin on the first surface of the first magnetic body.

Preferably, in the mixture of magnetic powder and the resin, a mass content of the resin is 50%–95%, which may be, for example, 50%, 60%, 70%, 80%, 90%, or 95%.

Preferably, pressure for hot-pressing is lower than the pressure for molding the first magnetic body.

Preferably, in the mixture of magnetic powder and the resin, the magnetic powder includes any one or a combination of at least two of iron–silicon–aluminum powder, iron–silicon powder, iron–nickel powder, iron–silicon–chromium powder, amorphous nanocrystalline powder, or carbonyl iron powder.

Preferably, in the mixture of magnetic powder and the resin, the resin includes a thermosetting resin and/or a thermoplastic resin. For example, the thermosetting resin may be any one or a combination of at least two of epoxy resin, diallyl phthalate resin, phenolic resin, polyimide, polyamide-imide, or silicone resin, and the thermoplastic resin may be any one or a combination of at least two of polyolefin, fluororesin, polyamide, polyester, polycarbonate, polyoxymethylene, acrylonitrile‑butadiene‑styrene copolymer (ABS resin), or styrene‑acrylonitrile copolymer (SAN or AS resin).

Preferably, the covering method includes the step below.

Covering a magnetic plate on the first surface of the first magnetic body.

It is to be noted that the magnetic plate is generally made of a ferromagnetic material (such as iron, nickel, cobalt, or an alloy thereof) or a magnetic material such as ferrite, or the magnetic plate can be formed by coating or pasting a magnetic coating or a magnetic film onto a common plate (such as a plastic plate or a metal plate) to impart magnetic properties.

Preferably, before the magnetic plate is covered on the first surface of the first magnetic body, an adhesive is applied to a region where the first magnetic body is connected to the magnetic plate. For example, the adhesive may be an epoxy resin adhesive, a polyurethane adhesive, or a silicone adhesive.

Preferably, when the first magnetic body in step (a) has at least two grooves, after the second magnetic body is stacked in step (c), a cutting process is further performed to form multiple independent inductors.

Preferably, after step (c), the manufacturing method further includes step (d), and step (d) includes:

forming electrodes on the inductor obtained in step (c) such that the electrodes are electrically connected to exposed ends of the winding.

Preferably, a method for forming the electrodes includes a coating method, a welding method, or a metalized electrode method.

Preferably, the coating method includes the steps below.

Applying a conductive paste to the inductor and performing a thermal processing to obtain the electrode.

Preferably, the thermal processing includes curing or sintering.

Preferably, in a case where the thermal processing is curing, the conductive paste includes metal powder particles and a resin. For example, the metal powder particles are Ag powder particles.

Preferably, in a case where the thermal processing is sintering, the conductive paste includes metal powder particles, an inorganic binder, and an organic binder. For example, the metal powder particles are Ag powder particles, the inorganic binder is glass powder, aluminum oxide, or zinc oxide, and the organic binder is ethyl cellulose, acrylic resin, or polyvinyl butyral.

Preferably, the sintering is performed at a temperature of 600–1000°C, which may be, for example, 600°C, 700°C, 800°C, 900°C, or 1000°C.

Preferably, in a case where the method for forming the electrodes is the welding method, the electrodes are prefabricated parts, that is, finished electrodes are welded to the ends of the winding exposed out of the inductor.

Preferably, the metallized electrode method includes any one or a combination of at least two of a physical vapor deposition method, a chemical vapor deposition method, a sputtering method, an electroplating method, or an electroless plating method.

Preferably, in a case where the method for forming the electrodes is the metallized electrode method, the electrode includes at least one conductive metal layer.

In a third aspect, the present disclosure provides an electronic device. The electronic device includes the inductor as described in the first aspect.

Numerical range in the present disclosure includes not only the above-listed point values but also any unlisted point values within the numerical range. Due to the limitation of space and the consideration of simplicity, specific point values included in the range are not exhaustively listed in the present disclosure.

Compared with the related art, the present disclosure has the beneficial effects below.

In the present disclosure, the winding is formed by using a combination of the conductive body and the conductive layer, so that when the inductors with the same volume are manufactured, the gap between the winding and the magnetic body can be reduced, thereby reducing the DCR and improving the current-carrying capability of the inductor. Moreover, the winding is placed in the magnetic member. Since the magnetic member and the winding are formed separately, the magnetic bodies with higher densities can be manufactured to improve the electromagnetic performance.

### BRIEF DESCRIPTION OF DRAWINGS

FIG. 1 is a structural view of a combination of inductors provided by Example 1 of the present disclosure.

FIG. 2 is a sectional view of a combination of inductors provided by Example 1 of the present disclosure.

FIG. 3 is a structural view of a first magnetic body provided by Example 1 of the present disclosure.

FIG. 4 is a structural view after step (2) provided by Example 1 of the present disclosure.

FIG. 5 is a structural view after step (3) provided by Example 1 of the present disclosure.

FIG. 6 is a structural view after step (4) provided by Example 1 of the present disclosure.

FIG. 7 is a structural view after step (5) provided by Example 1 of the present disclosure.

FIG. 8 is a structural view after step (6) provided by Example 1 of the present disclosure.

FIG. 9 is a sectional view of a combination of inductors provided by Example 10 of the present disclosure.

FIG. 10 is a sectional view of a combination of inductors provided by Example 11 of the present disclosure.

FIG. 11 is a sectional view of a combination of inductors provided by Example 12 of the present disclosure.

FIG. 12 is a structural view after step (2) provided by Example 13 of the present disclosure.

FIG. 13 is a structural view of a combination of inductors provided by Example 13 of the present disclosure.

### REFERENCE LIST

1 inductor

2 first magnetic body

3 strip-shaped groove

4 conductive body

5 conductive layer

6 second magnetic body

7 cutting line

8 electrode

9 conductive pin

### DETAILED DESCRIPTION

Technical solutions of the present disclosure are further described below through examples. It is to be understood by those skilled in the art that the examples are intended to facilitate understanding of the present disclosure and are not to be construed as limiting the present disclosure.

### Example 1

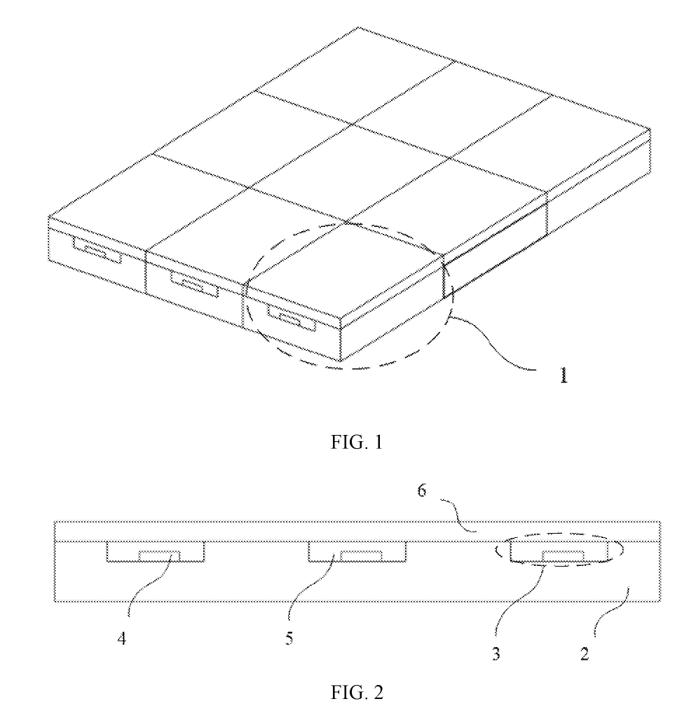

This example provides an inductor. FIG. 1 is a structural view of a combination of such inductors. FIG. 2 is a sectional view of the combination of such inductors. The inductor 1 included:

A first magnetic body 2. A strip-shaped groove 3 was defined on a first surface of the first magnetic body 2. The strip-shaped groove 3 penetrated through the first surface of the first magnetic body 2. The number of the strip-shaped grooves 3 can be selected according to actual requirements. For example, the strip-shaped groove 3 may be three in number, and the three strip-shaped grooves 3 were spaced apart from each other and arranged in parallel.

A winding. The winding was disposed in the strip-shaped groove 3. The winding included a conductive body 4 and a conductive layer 5 disposed between the conductive body 4 and the strip-shaped groove 3. The conductive layer 5 was formed between the conductive body 4 and the inner wall of the strip-shaped groove 3 and covered an upper end surface of the conductive body 4. An upper end surface of the conductive layer 5 was flush with the first surface of the first magnetic body 2. The conductive body 4 was a copper strip, and a material of the conductive layer 5 was copper. A cross-section of the strip-shaped groove 3 was rectangular, and a cross-section of the copper strip was rectangular. An interval between the conductive body 4 and a sidewall of the strip-shaped groove 3 was equal. A conductivity of the conductive layer 5 was greater than a conductivity of the conductive body 4.

A second magnetic body 6. The second magnetic body 6 was stacked on the first surface of the first magnetic body 2 and covered the winding.

The inductor further included end electrodes. The end electrodes were located in electrode regions of the inductor and electrically connected to exposed ends of the winding. A material of the end electrodes was Ag.

It is to be understood that horizontal and vertical cross lines in FIG. 1 represent cutting lines for cutting the combination of inductors into multiple independent inductors.

This example further provides a manufacturing method for the inductor. The manufacturing method includes the steps below.

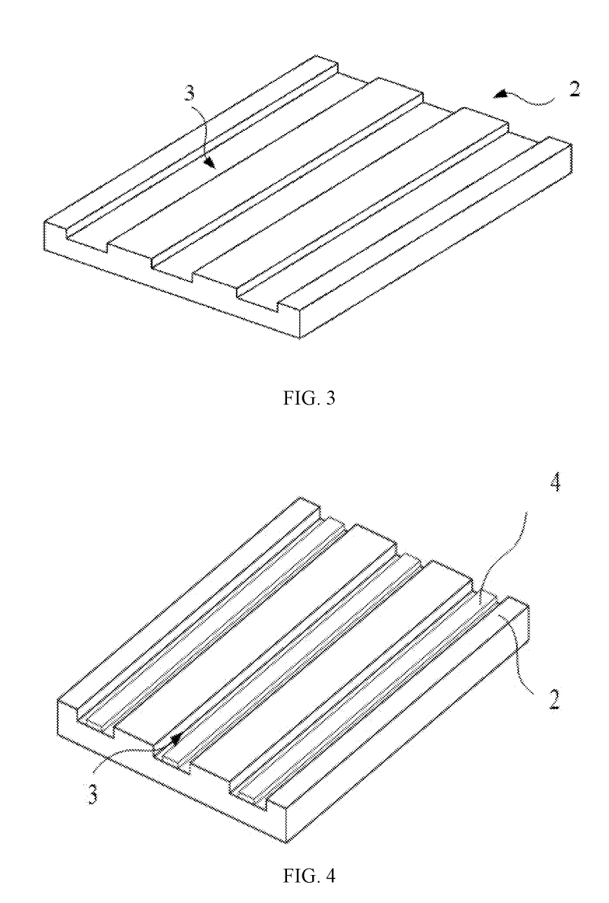

(1) The first magnetic body 2 with three strip-shaped grooves 3 was manufactured, as shown in FIG. 3.

An insulating layer was formed on an outer surface of iron–silicon–aluminum powder. A material of the insulating layer was aluminum phosphate. The iron–silicon–aluminum powder with the insulating layer was mixed with epoxy resin at a mass ratio of 1:0.1 and subjected to granulation to obtain granulated powder.

The granulated powder was filled into a mold cavity, compression-molded under a pressure of 13 T/cm², placed in an annealing furnace, and subjected to a heat treatment (that is, thermal annealing) at 600°C to obtain the first magnetic body 2. It is to be understood that the grooves 3 may be compression-molded or formed after compression molding.

(2) Copper strips were placed in the strip-shaped grooves 3 of the first magnetic body 2, where the upper end surface of each copper strip was lower than the first surface of the first magnetic body 2, as shown in FIG. 4.

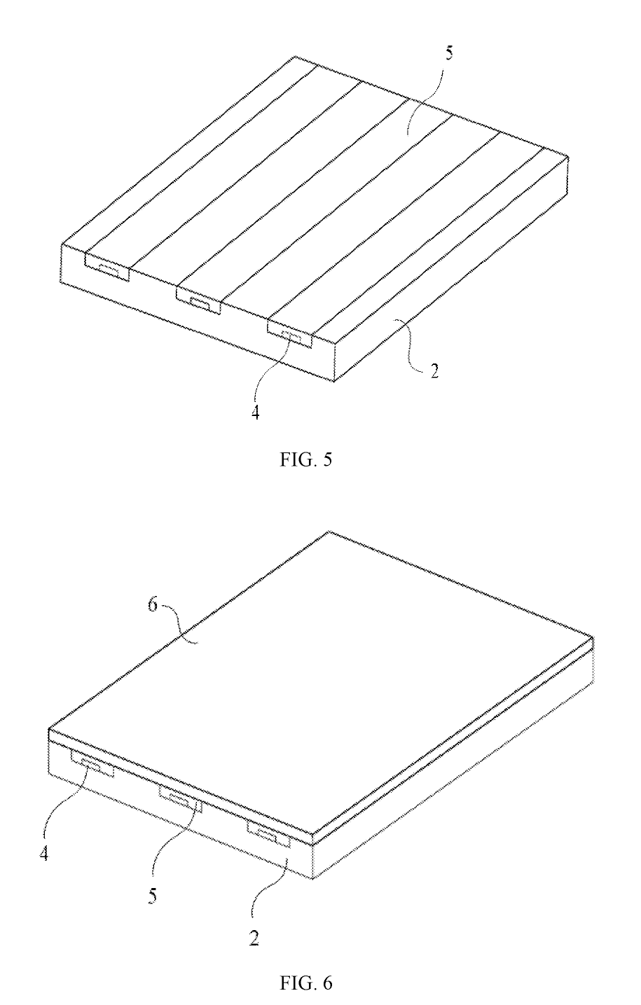

(3) The conductive layer 5 was formed in the strip-shaped groove 3 of the first magnetic body 2 through a thick copper process by an electroplating method to obtain the winding, as shown in FIG. 5. The conductive layer 5 was formed between the copper strip and the inner wall of the strip-shaped groove and covered the upper end surface of the copper strip. The upper end surface of the conductive layer 5 was flush with the first surface of the first magnetic body 2. For example, the thickness of the copper strip was 0.1 mm, and the thickness of the conductive layer was 0.15 mm.

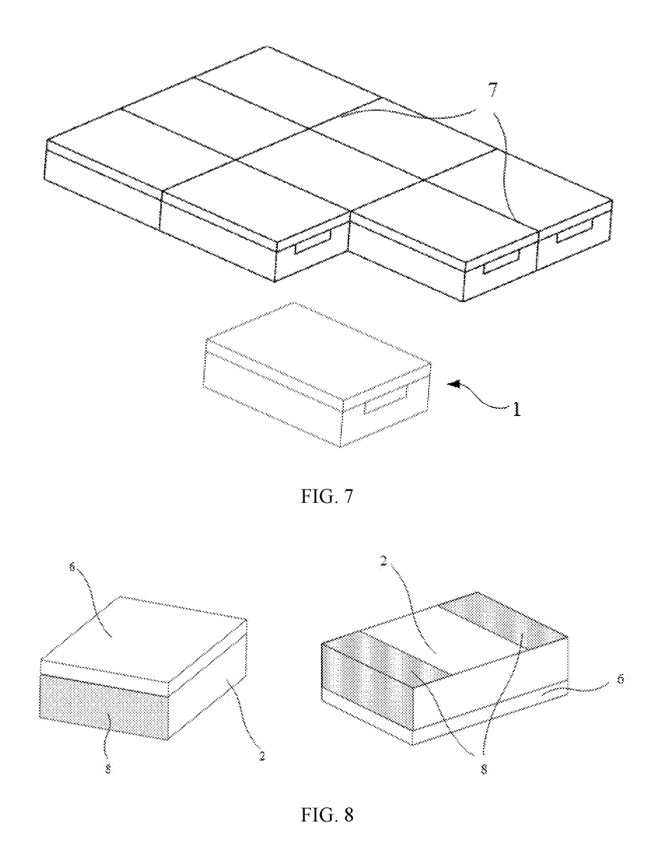

(4) A mixture of iron–silicon–aluminum powder and epoxy resin was hot-pressed on the first surface of the first magnetic body 2 and covered the winding to form the second magnetic body 6 and obtain the combination of inductors, as shown in FIG. 6. In the mixture of iron–silicon–aluminum powder and epoxy resin, the mass content of epoxy resin was 70%.

(5) The combination of inductors was cut into the multiple independent inductors 1, as shown in FIG. 7. The horizontal and vertical cross lines in the figure represent the cutting lines.

(6) A conductive silver paste was applied to the electrode regions of the inductor 1, connected to the exposed ends of the winding, and cured to form the electrodes 8, as shown in FIG. 8 (where the right figure is an inverted view of the left figure). The conductive paste included Ag powder particles and epoxy resin, and the mass content of epoxy resin was 5%.

### Example 2

This example differs from Example 1 in that the thermal annealing in step (1) was replaced with thermal curing, that is, the compression-molded first magnetic body was cured at 200°C.

Other manufacturing methods and parameters remained the same as those in Example 1.

### Example 3

This example differs from Example 1 in that the mixture of iron–silicon–aluminum powder and epoxy resin in step (4) was replaced with a magnetic plate, and the magnetic plate directly covered on the first surface of the first magnetic body.

Other manufacturing methods and parameters remained the same as those in Example 1.

### Example 4

This example differs from Example 3 in that before covering the magnetic plate, an epoxy resin adhesive was applied to a region where the first magnetic body was connected to the magnetic plate, and then the magnetic plate was covered on the first magnetic body.

Other manufacturing methods and parameters remained the same as those in Example 3.

### Example 5

This example differs from Example 1 in that curing in step (6) was replaced with sintering at 600°C, and the conductive paste included Ag powder particles, an aluminum oxide binder, and an ethyl cellulose binder.

Other manufacturing methods and parameters remained the same as those in Example 1.

### Example 6

This example differs from Example 1 in that the electrodes in step (6) were manufactured by a welding method, including welding a wire frame made of copper to an end of the winding exposed out of the inductor.

Other manufacturing methods and parameters remained the same as those in Example 1.

### Example 7

This example differs from Example 1 in that the electroplating method in step (3) was replaced with a coating method. The coating method includes the steps below.

A conductive paste was applied between the conductive body and the inner wall of the strip-shaped groove and sintered at 700°C to form the conductive layer, where the conductive paste included Ag powder.

Other manufacturing methods and parameters remained the same as those in Example 1.

### Example 8

This example differs from Example 1 in that the electroplating method in step (3) was replaced with a coating method. The coating method includes the steps below.

A conductive paste was applied between the conductive body and the inner wall of the strip-shaped groove, and the conductive layer was formed at 250°C, where the conductive paste included nanoscale Ag particles and microscale Ag particles.

Other manufacturing methods and parameters remained the same as those in Example 1.

### Example 9

This example differs from Example 1 in that a connecting body was provided on the conductive body, and the connecting body was configured to connect multiple conductive bodies to form a conductive structure so that the conductive bodies were disposed in the strip-shaped grooves of the first magnetic body in one-to-one correspondence.

Other manufacturing methods and parameters remained the same as those in Example 1.

### Example 10

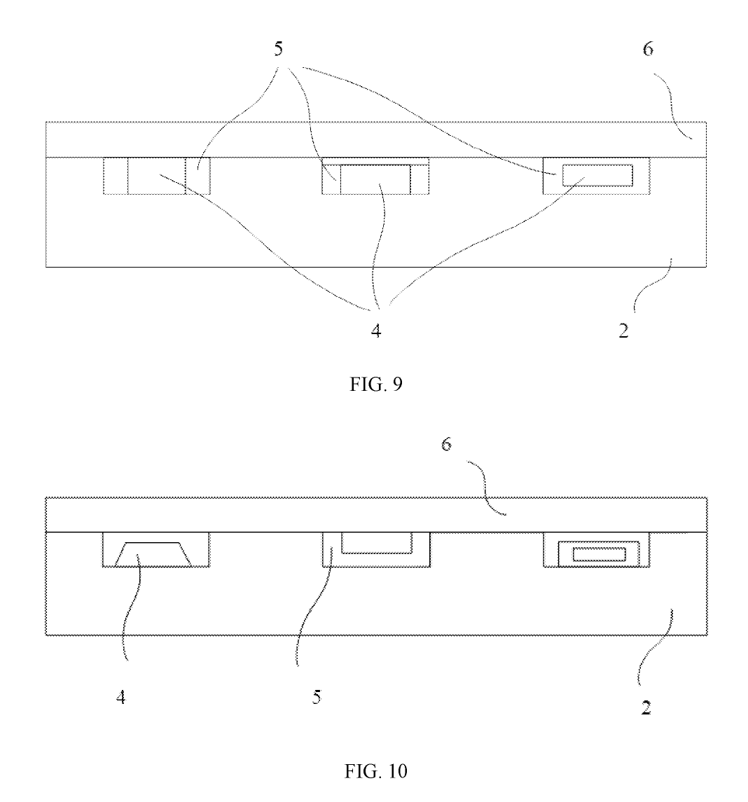

This example differs from Example 1 in that, in the inductor, the conductive body and the conductive layer cover the following cases, as shown in FIG. 9.

The conductive layer was formed between the conductive body and the inner wall of the strip-shaped groove, the upper end surface of the conductive layer and the upper end surface of the conductive body were flush with the first surface of the first magnetic body, and a lower end surface of the conductive body was attached to a bottom surface of the groove.

The conductive layer was formed between the conductive body and the inner wall of the strip-shaped groove, and the upper end surface of the conductive layer was flush with the upper end surface of the conductive body and lower than the first surface of the first magnetic body.

The conductive layer was formed between the conductive body and the inner wall of the strip-shaped groove, covered the upper end surface of the conductive body, and was formed between the lower end surface of the conductive body and the bottom surface of the strip-shaped groove, and the upper end surface of the conductive layer was flush with the first surface of the first magnetic body.

Other manufacturing methods and parameters remained the same as those in Example 1.

### Example 11

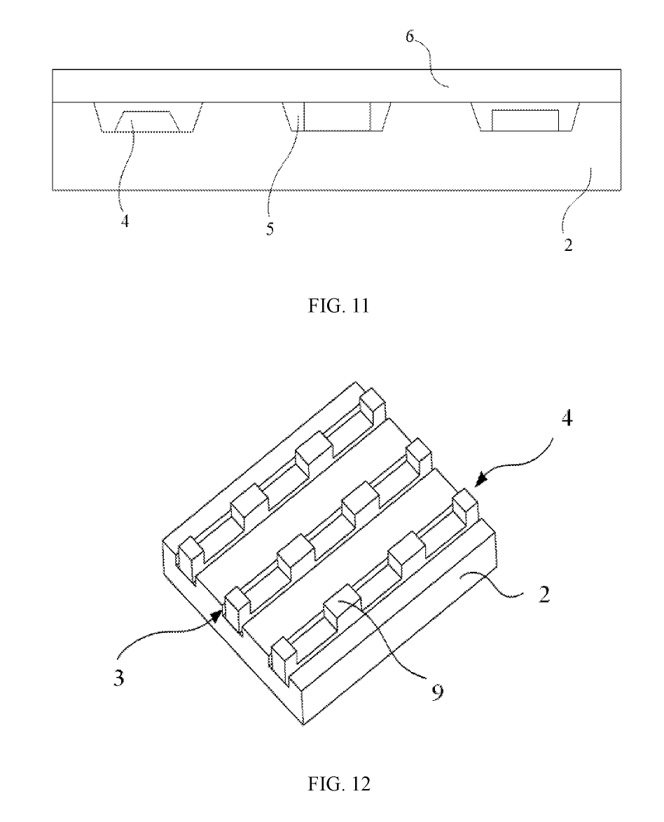

This example differs from Example 1 in that, in the inductor, the conductive body and the conductive layer cover the following cases, as shown in FIG. 10.

The conductive layer was formed between the conductive body and the inner wall of the strip-shaped groove and covered the upper end surface of the conductive body, the upper end surface of the conductive layer was flush with the first surface of the first magnetic body, and the lower end surface of the conductive body was attached to the bottom surface of the strip-shaped groove. The cross-section of the conductive body was in the shape of a regular trapezoid, that is, along a thickness direction of the conductive body, the interval between the conductive body and the sidewall of the groove gradually increased.

The conductive layer was formed between the conductive body and the inner wall of the strip-shaped groove and between the lower end surface of the conductive body and the bottom surface of the strip-shaped groove, and the upper end surface of the conductive layer and the upper end surface of the conductive body were flush with the first surface of the first magnetic body.

The conductive layer was formed between the conductive body and the inner wall of the strip-shaped groove and covered the upper end surface of the conductive body, the upper end surface of the conductive layer was flush with the first surface of the first magnetic body, and the lower end surface of the conductive body was attached to the bottom surface of the groove. The cross-section of the conductive body was in the shape of a regular trapezoid, that is, along the thickness direction of the conductive body, the interval between the conductive body and the sidewall of the groove gradually increased. The conductive body had a hollow structure.

Other manufacturing methods and parameters remained the same as those in Example 1.

### Example 12

This example differs from Example 1 in that the cross-section of the groove was in the shape of an inverted trapezoid, and in the inductor, the conductive body and the conductive layer cover the following cases, as shown in FIG. 11.

The conductive layer was formed between the conductive body and the inner wall of the strip-shaped groove and covered the upper end surface of the conductive body, the upper end surface of the conductive layer was flush with the first surface of the first magnetic body, and the lower end surface of the conductive body was attached to the bottom surface of the groove. The cross-section of the conductive body was in the shape of a regular trapezoid or a rectangle.

The conductive layer was formed between the conductive body and the inner wall of the strip-shaped groove, the upper end surface of the conductive layer and the upper end surface of the conductive body were flush with the first surface of the first magnetic body, and the lower end surface of the conductive body was attached to the bottom surface of the groove.

Other manufacturing methods and parameters remained the same as those in Example 1.

### Example 13

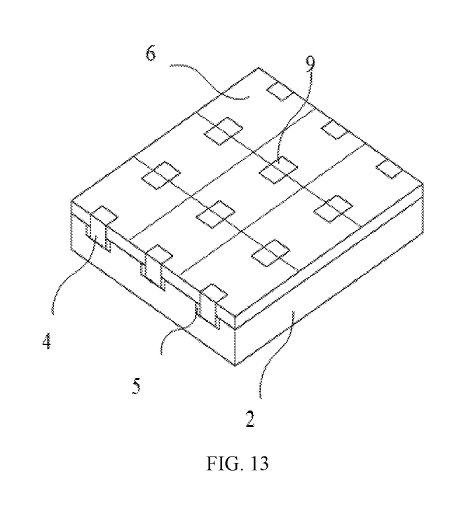

This example differs from Example 1 in that no end electrodes were disposed on the inductor. Referring to FIGS. 12 and 13, the conductive body 4 was provided with conductive pins 9, the conductive pins 9 protruded on a surface of the conductive body 4 facing away from the first magnetic body 2, extended in a direction towards the second magnetic body 6, and penetrated through the second magnetic body 6, and the conductive pins 9 were arranged at intervals along an extension direction of the conductive body 4. Each independent inductor 1 after cutting included two conductive pins 9 exposed out of the second magnetic body 6 to be electrically connected to an external circuit.

The density of the first magnetic body 2 was greater than the density of the second magnetic body 6, the permeability of the first magnetic body 2 was greater than the permeability of the second magnetic body 6, and the material of the conductive pins 9 were the same as the material of the conductive body 4. The hardness of the first magnetic body 2 was greater than the hardness of the second magnetic body 6.

Other manufacturing methods and parameters remained the same as those in Example 1.

It is to be understood that the horizontal and vertical cross lines in FIG. 13 represent the cutting lines for cutting the combination of inductors into multiple independent inductors. Each independent inductor included two conductive pins exposed out of the second magnetic body.

### Example 14

This example differs from Example 1 in that the thermal annealing in step (1) was performed at 300°C.

Other manufacturing methods and parameters remained the same as those in Example 1.

### Example 15

This example differs from Example 1 in that the thermal annealing in step (1) was performed at 1100°C.

Other manufacturing methods and parameters remained the same as those in Example 1.

Specifically, as can be seen from the comparison of Example 1 with Examples 14 and 15, if the annealing temperature is too low, that is, as low as 300°C, the relatively low temperature is insufficient to release the internal residual stress, easily resulting in a relatively low permeability and a relatively high loss; if the annealing temperature is too high, that is, as high as 1100°C, the insulating layer on the surface of powder is easily damaged, reducing the initial permeability and increasing the eddy current loss.

To conclude, in the present disclosure, the conductive body and the conductive layer at particular positions are combined into the winding so that when the inductors with the same volume are manufactured, the gap between the winding and the magnetic body can be reduced or avoided, thereby reducing the DCR of the inductor (which is positively correlated to a resistivity of the winding and negatively correlated to a cross-section of the winding) and improving the current-carrying capability of the inductor. Moreover, the conductive body is placed in the strip-shaped groove of the first magnetic body, the gap between the conductive body and the magnetic body is filled with the conductive layer, and the second magnetic body is covered on the winding. Since the magnetic bodies and the winding are formed separately, a limitation of the winding on the molding pressure during integral forming in the related art can be avoided, and thus the magnetic bodies with higher densities can be manufactured to improve the electromagnetic performance. Additionally, when the conductive pins protrude on the conductive body, the first magnetic body is formed through high-pressure pressing, and the second magnetic body is formed through low-pressure pressing, thereby ensuring the electromagnetic performance of the inductor and avoiding an effect on the conductive pins during the formation of the second magnetic body.

It is to be understood that based on the preceding examples, when the manufacturing method does not include step (3), that is, the conductive layer 5 is not disposed between the conductive body 4 and the groove 3, and instead, the magnetic mixture is directly filled into the gap between the conductive body 4 and the groove 3 through step (4). The conductive body 4 may partially protrude out of the groove 3. Such manufacturing manner enables the second magnetic body 6 to be well connected to the conductive body 4. However, when the overall size of the inductor 1 is relatively small, the direct formation of the conductive layer 5 in the gap between the conductive body 4 and the groove 3 is easier to implement and can increase the current-carrying capability. It is to be further understood that, based on the preceding examples, when the manufacturing method does not include step (2), that is, the conductive layer is directly disposed in the groove to form the winding. In a case where the inductor 1 has a relatively large overall size with a higher electromagnetic performance required, or a winding with a larger cross-section is required at the same volume, the winding is directly formed through metallization, which requires a longer production time and a higher cost.

The applicant has stated that although the process methods of the present disclosure are described through the preceding examples, the present disclosure is not limited to the preceding process steps, which means that implementation of the present disclosure does not necessarily depend on the preceding process steps. It is to be understood by those skilled in the art that any improvements made to the present disclosure, equivalent replacements of raw materials selected in the present disclosure, additions of adjuvant ingredients, and selections of specific methods, etc., all fall within the protection scope and the disclosed scope of the present disclosure.

What is claimed is:

1. An inductor, comprising a winding and a magnetic member that at least partially covers the winding, wherein the winding comprises a conductive body and a conductive layer disposed on a surface of the conductive body.

2. The inductor according to claim 1, wherein the magnetic member comprises:
a first magnetic body, and a groove is defined on a first surface of the first magnetic body, the winding is disposed in the groove, and the winding is attached to an inner wall of the groove; and
a second magnetic body, and the second magnetic body is stacked on the first surface of the first magnetic body and covering the winding.

3. The inductor according to claim 2, wherein the conductive body is provided with conductive pins, and the conductive pins protrude on a surface of the conductive body facing away from the first magnetic body, extend in a direction towards the second magnetic body and penetrate through the second magnetic body; and a density of the first magnetic body is greater than a density of the second magnetic body, and/or a permeability of the first magnetic body is greater than a permeability of the second magnetic body.

4. The inductor according to claim 2, wherein materials of the conductive body and the conductive layer each independently comprise a metal material and/or a carbon material;
the metal material comprises any one or a combination of at least two of Au, Pt, Pd, Ag, Cu, Al, Co, Cr, Zn, Ni, Ti, W, Fe, Sn, or In.

5. The inductor according to claim 2, wherein a position relationship between the conductive layer and the conductive body comprises at least one of the following:
the conductive layer is formed between the conductive body and the inner wall of the groove and covers an upper end surface of the conductive body; or
the conductive layer is formed between the conductive body and the inner wall of the groove, and an upper end surface of the conductive layer is flush with an upper end surface of the conductive body.

6. The inductor according to claim 5, wherein an interval between the conductive body and a sidewall of the groove is equal or gradually increases along a thickness direction of the conductive body.

7. The inductor according to claim 2, wherein the conductive body has a multi-layer structure or a hollow structure.

8. The inductor according to claim 2, wherein a conductivity of the conductive layer is greater than a conductivity of the conductive body.

9. The inductor according to claim 1, wherein a connecting body is provided on the conductive body, and the connecting body is configured to connect a plurality of conductive bodies to form a conductive structure;
a material of the connecting body comprises a metal material and/or a carbon material; and
the inductor further comprises end electrodes, and the end electrodes are electrically connected to exposed ends of the winding.

10. A manufacturing method for the inductor according to claim 1, comprising:
disposing a conductive body at least partially in a magnetic member, and disposing a conductive layer on a surface of the conductive body to form a winding, to obtain the inductor.

11. The manufacturing method according to claim 10, comprising:
(a) manufacturing a first magnetic body with a groove;
(b) placing the conductive body in the groove of the first magnetic body, and forming the conductive layer in the groove through a metallization process such that the conductive layer is disposed on the surface of the conductive body and located between the conductive body and the groove to obtain the winding; and
(c) stacking a second magnetic body on a first surface of the first magnetic body, and covering winding.

12. The manufacturing method according to claim 11, wherein a method for manufacturing the first magnetic body with the groove in step (a) comprises:
mixing soft magnetic powder with a resin and performing granulation to obtain granulated powder; and
subjecting the granulated powder to compression molding and a first heat treatment to obtain the first magnetic body with at least one groove;
the soft magnetic powder comprises any one or a combination of at least two of iron–silicon–aluminum powder, iron–silicon powder, iron–nickel powder, iron–silicon–chromium powder, amorphous nanocrystalline powder, or carbonyl iron powder;
the resin comprises a thermosetting resin and/or a thermoplastic resin.

13. The manufacturing method according to claim 12, wherein pressure for the compression molding is 2–24 T/cm²;
the first heat treatment is performed in a manner of thermal annealing or thermal curing; and
the thermal annealing is performed at a temperature of 300–1000°C.

14. The manufacturing method according to claim 11, wherein the metallization process in step (b) comprises any one or a combination of at least two of a coating method, a sputtering method, a vapor deposition method, an electroplating method, a spraying method, an aerosol deposition method, or a thermal spraying method.

15. The manufacturing method according to claim 14, wherein the coating method comprises:
applying a conductive paste between the conductive body and an inner wall of the groove, and performing a second heat treatment to obtain the conductive layer.

16. The manufacturing method according to claim 11, wherein in step (c), a method for stacking the second magnetic body comprises a hot pressing method or a covering method;
the hot pressing method comprises:
hot-pressing a mixture of magnetic powder and a resin on the first surface of the first magnetic body; and
in the mixture of magnetic powder and the resin, a mass content of the resin is 50%–95%.

17. The manufacturing method according to claim 16, wherein the covering method comprises:
covering a magnetic plate on the first surface of the first magnetic body.

18. The manufacturing method according to claim 11, wherein when the first magnetic body in step (a) has at least two grooves, after the second magnetic body is stacked in step (c), a cutting process is further performed to form a plurality of independent inductors.

19. The manufacturing method according to claim 11, which further comprises step (d) after step (c), and step (d) comprises:
forming electrodes on the inductor obtained in step (c) such that the electrodes are electrically connected to exposed ends of the winding; and
a method for forming the electrodes comprises a coating method, a welding method, or a metalized electrode method.

20. An electronic device, comprising the inductor according to claim 1.
